(19) United States
(12) Patent Application Publication
(10) Pub. No.: US 2017/0178152 A1
(43) Pub. Date: Jun. 22, 2017

(54) METHOD AND APPARATUS TO IDENTIFY CO-ENTITIES BASED ON SPARSE LOCATION INFORMATION

(71) Applicant: THOMSON LICENSING, Issy les Moulineaux (FR)

(72) Inventors: Erwan LE MERRER, Rennes (FR); Patrick FONTAINE, Rennes (FR)

(21) Appl. No.: 14/977,165

(22) Filed: Dec. 21, 2015

(51) Int. Cl. G06Q 30/02; H04W 4/04

(52) U.S. Cl. CPC G06Q 30/0201; H04W 4/04

(57) ABSTRACT

A method and apparatus to identify co-entities in an establishment. Given a set of points in a three dimensional space, along with identification information from mobile devices and a timestamp, a times series for each device may be captured. Time series that overlap may be generated, and the intersecting time series portions may be extracted. Based on the extracted overlapping time series, a determination may be made that two or more entities are likely to be co-entities.

### BACKGROUND

Location based tracking of consumers is relied on by retailers in order to influence consumer behavior and promote purchases via big data analytics. Currently, various tracking mechanisms may include video identification, mobile device identification via Wi-Fi, beacons, or Bluetooth detection, movements in retail zones, etc. that track location information about visitors throughout a retail environment.

All these tracking mechanisms may be able to identify the number of visitors and their movements, but suffer from the drawback of not being able to ascertain when two or more identified consumers are co-entities. Accordingly, co-visitors may be treated as individual entities during data analysis, when a more accurate analysis should have the co-visitors treated as a single entity.

Thus, there is a need for a mechanism to identify when two or more tracked entities in an environment are co-entities.

### SUMMARY

Some embodiments provide a method and apparatus to identify co-entities in a retail environment, for example. As information about consumer mobile devices are readily available and trackable, a time series of movement within an establishment may be ascertained for each device that enters an establishment. Using the time series of each identified consumer device, two or more time series may be identified as overlapping. These overlapping time series may then be further analyzed to determine that two or more consumers may be co-entities rather than individual entities visiting an establishment at the same time. This identification method may also cover other scenarios like co-visitors of an attractions such as museums, theme parks, etc.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of a retail system according to an exemplary embodiment;

FIG. 2 illustrates a schematic block diagram of a mobile device and detection device within the establishment of FIG. 1;

FIG. 3 illustrates a flow chart of an exemplary process used by some embodiments to identify co-entities;

FIG. 4 illustrates two exemplary time series for two different consumer devices; and

FIG. 5 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various inventive features are described below that can each be used independently of one another or in combination with other features. Broadly, some embodiments generally provide:

A first exemplary embodiment provides a method that captures a time series of tuples (including position, time for instance) for each visitor/consumer during a pre-defined time period where each time series is discretized into time buckets. Groups of overlapping time series may be generated. The method may then extract intersections of time series and subsequently determine that two or more persons are co-entities based on the intersections.

A second exemplary embodiment provides an apparatus that captures a time series of tuples for each visitor/consumer during a pre-defined time period where each time series is discretized into time buckets. Groups of overlapping time series may be generated by the apparatus. The apparatus may then extract intersections of time series and subsequently determine that two or more persons are co-entities based on the intersections.

Several more detailed embodiments are described in the sections below. Section I provides a description of an exemplary system architecture used by some embodiments. Section II then describes various exemplary methods of operation used by some embodiments. Next, Section III described several example use cases of some embodiments. Lastly, Section IV describes a computer system which implements some of the embodiments.

### I. System Architecture

Some embodiments of the present disclosure provide a method and apparatus for identifying co-entities from sparse location information. Detection of consumer devices may allow the tracking of devices as they move throughout an establishment. Some embodiments may send the tracking information to a central analytics engine for analysis of consumer traffic patterns, purchase behaviors, award redemption etc. The central analytics engine may also be able to identify when two or more persons are co-entities.

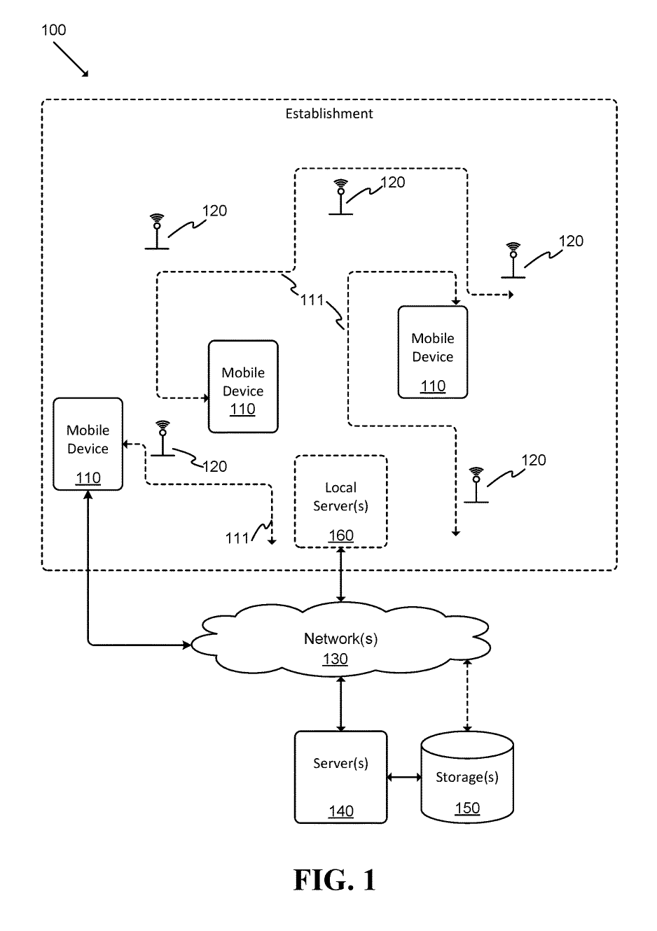

FIG. 1 illustrates a schematic block diagram of an establishment 100 of some embodiments. An establishment 100 may represent a physical location or structure (e.g., a retail store, museum, attraction, etc.) or section thereof (e.g., an area within a department store or grocery store). Each establishment may be defined in various appropriate ways (e.g., using a set of geographic coordinates). The establishment 100 illustrates several mobile devices 110 (e.g., smartphones, tablets, wearable devices, or any similar terminal device) that a visitor/consumer may carry along different paths 111 within the establishment 100.

As shown, the system 100 may also include, several detection devices 120, one or more local servers 160, one or more networks 130, one or more servers 140, and one or more storages 150. In the example of FIG. 1, the elements may represent locations on a two-dimensional representation of a physical area. One of ordinary skill in the art will recognize that different physical locations may have different specific attributes and/or different specific types of areas. For instance, a single establishment may include multiple levels where some areas are associated with a single level and other areas span multiple levels.

Some embodiments may include a local server 160 that is able to interact with the detection devices 120. Such a local server 160 may be able to access one or more local storages (not shown). In some embodiments, the detection devices may communicate with the local server 160 over a local network (e.g., wireless or wired), with the local server 160 providing a communication path from the detection devices 120 to the servers 140 and/or storages 150. In some embodiments, the detection devices 120 may be able to communicate directly over network 130 without using a local server 160 (e.g., wireless Internet, Bluetooth, cellular communication, etc.).

The network(s) 130 may allow the mobile device 110 and/or detection devices 120 to communicate with one or more servers 140 and/or storages 150. In this way, the mobile device 110 and/or detection devices 120 may be able to send commands or other information to the server 140 and/or storages 150. Likewise, the server 140 may be able to send commands or information to the mobile device 110 and/or detection devices 120. Such networks 130 may include networks such as wired networks (e.g., Ethernet), wireless networks or communication channels (e.g., Wi-Fi, Bluetooth, NFC, etc.), cellular networks, etc.

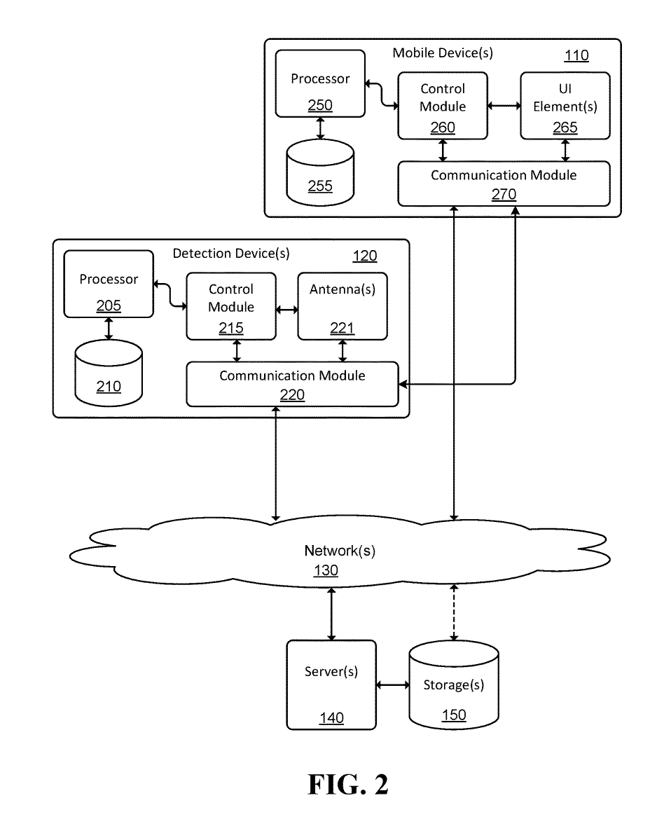

FIG. 2 illustrates a schematic block diagram of a mobile device 110 and detection device 120 within the establishment 100 of FIG. 1. As shown, the mobile device 110 may include a processor 250, storage 255, control module 260, UI elements 265, and communication module 270. The processor 250 may be able to execute instructions and/or manipulate data. The storage 255 may be able to store sets of instructions, data, operating parameters, etc. The control module 260 may control the operations of the mobile device 110. For instance, the control module 260 may push content to a display screen of the device 110. The UI elements 265 may include output elements (e.g., a display screen, speakers, etc.), input elements (e.g., buttons, keypad, etc.), and/or input/output elements (e.g., a touchscreen). The communication module 270 may support several different communication protocols including WiFi, Bluetooth, NFC, Cellular, etc., and allow the mobile device 110 to send and/or receive instructions and/or data over the network 130 or via the detection devices 120.

The detection device(s) 120 may include a processor 205, storage 210, control module 215, communication module 220, and one or more antennas 221. The processor 205 may be able to execute instructions and/or manipulate data. The storage 210 may be able to store sets of instructions, data, operating parameters, etc. The control module 215 may control the operations of the detection devices 120. For instance, the control module 215 may define various parameters associated with signals generated by the one of more antennas 221 (e.g., interval, duration, range, identifiers, etc.). The one or more antennas may include antennas that support several different communication protocols including WiFi, Bluetooth, NFC, Cellular, etc. The communication module 220 may allow the detection device 120 to send and/or receive instructions and/or data over the network 130. The detection device 120 may take the form of an access point, a router, a Bluetooth receiver, NFC chips, or a specialty device having the capability to communicate with one or more of the aforementioned protocols.

According to some embodiments of the present disclosure, the detection device 120 may actively or passively detect mobile devices 110 and gather identification information about the mobile device 100. For example, a MAC address may be read or captured by the detection device 120 in some embodiments. Other embodiments may be able to create unique models (e.g., profiles or device fingerprint) of each device in order to uniquely identify the mobile device 110. Section II will provide further detail on the methods used by some embodiments of the present disclosure, using the aforementioned architecture, to identify co-entities.

One of ordinary skill in the art will recognize that different embodiments may be implemented using various different data structures than shown. For instance, some embodiments may include additional elements and/or may omit elements. As another example, different embodiments may utilize various combined and/or divided data structures.

### II. Methods of Operation

In order to identify visitors or consumers as co-entities via their mobile devices 110, some embodiments of the present disclosure may receive, at the detection devices 120, identification information of the device (e.g., MAC address). In some embodiments, the identification information may be stored as “IDᵢ”. When the identification information is received, a timestamp “tₛ” may be associated with IDᵢ. Furthermore, coordinates (e.g., x, y, z) of the mobile device 110 or detection device 120 may also be associated with IDᵢ at the time of detection. Accordingly, the inputs received from the system include a set S of tuples of the form <IDᵢ, tₛ, x, y, z>, with i being a given person (i.e. mobile device 110).

The location tuple <x, y, z> may be derived from the system 100 by estimating the position of a device 110. In the case of a GPS location system, may be a conversion from a tuple <latitude, longitude, altitude>. In the case of a proximity detection device, a location tuple <x, y, z> may be associated to each detection device in the covered area using a common coordinate system.

Additionally, pre-defined zones may also be set up where devices may be identified where the zone is associated with a particular location tuple <x, y, z>. The location tuple may also correspond to a physical center of a zone, which may be relevant when zone configurations include zones of similar sizes and shapes. Moreover, a conversion between a zone and a location tuple <x, y, z> may be defined where x and or y are incremented by 1 between adjacent zones, and z is incremented by 1 or higher between zones separated by one or more floors.

With i, j, k, l, m, o being individual entities, an output O of the form (<i, l>, <k>, . . . , <j, m, o>) is desired, where each tuple in the output represents a relation between its contained entities, that is, the visitor/consumer within each tuple are determined to be co-entities. To get output O, some embodiments may create a relational set of numerous individual location measurements, as discussed above, which are then analyzed based on a time series, where time is discretized or separated into buckets (e.g., seconds, 5's of seconds, minutes, etc.). Specifically, a time series may be leveraged for determining proximity between paths of individual entities. From this proximity, some embodiments may derive that two or more given entities are likely to have visited together.

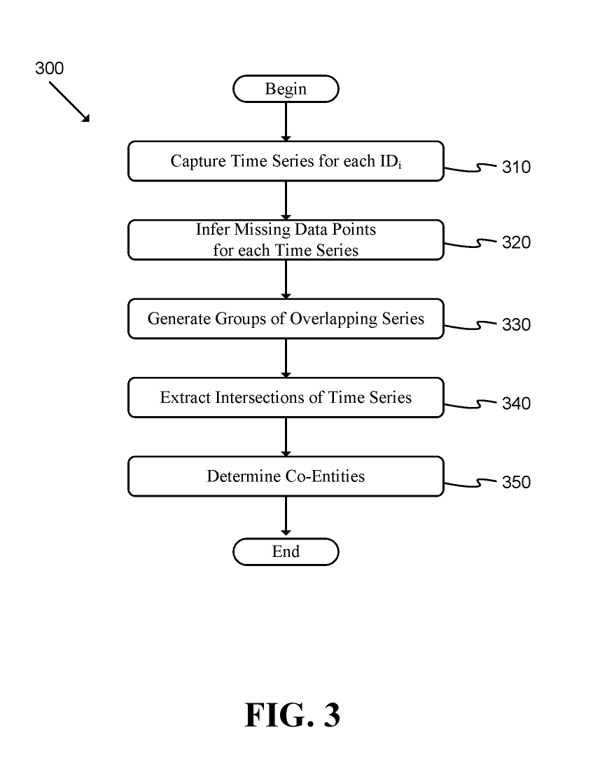

FIG. 3 illustrates a general flow chart of an exemplary process used by some embodiments to determine if two or more entities are co-entities. As shown the process 300 may begin by capturing (at 310) a time series S for each new IDᵢ detected during a predefined monitored time period (e.g., a normal opening day in a retail establishment). Each time series S is thus identified by IDᵢ, time is represented by each discrete bucket, and each bucket is associated a location tuple <x, y, z>.

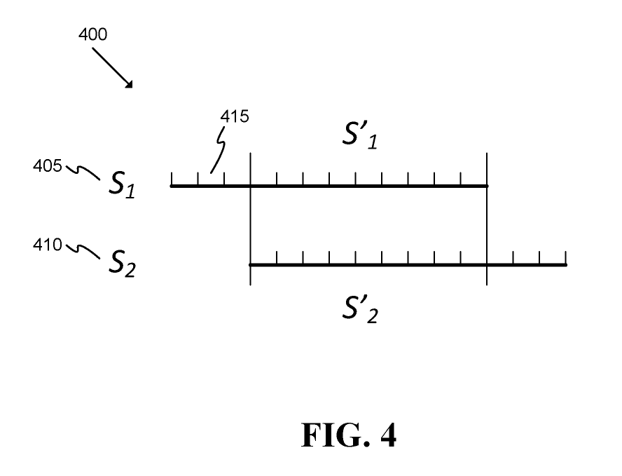

FIG. 4 illustrates two exemplary time series S₁ 405 and S₂ 410 for two different identified devices. As illustrated, each time series may have time discretized into several buckets 415.

At this point, each time series S may contain data points, and possibly many holes, i.e. buckets with no values inside. These holes may occur, for example, when no location tuple is captured at a particular time/bucket for the device associated with the time series. Next, the process 300 may fill the holes by inferring (at 320) the missing data points, i.e. a path that a visitor may have traveled between two known data points. This filling may be achieved by linear interpolation, for example.

The process 300 may then generate (at 330) groups of overlapping series. Two series overlap if and only if they share at least one bucket. That is, the location tuple for a particular bucket in the time series is the same. Then, for all pairs S₁,S₂ of a series that belongs to a same group of overlapping series, the process 300 may extract (at 340) the intersection of time spans of S₁,S₂ as S′₁,S′₂.

In a first example embodiment, for each S′₁, S′₂ the following computation may be made to ascertain the absolute distance between the two entities associated with time series S₁ and S₂.

$$d ( s 1 , s 2 ) = \sqrt{{\sum }_{t = 0}^{length ( {s}^{′} 1 )} {( {coord}_{t} ( {s}_{1}^{′} ) - {coord}_{t} ( {s}_{2}^{′} ) )}^{2}} ,$$

where coord_t(s′1) indicates the coordinate of entity 1 recorded in the t^{th} bucket s′1.

In a second example embodiment, for all buckets in S′₁ if (coord_t(S′₁)−coord_t(S′₂))²<Θ, where Θ represents a distance assessed as “close” for two entities in the current setup, then i←i+increment. As each intersected time series is analyzed, the process 300 may determine (at 350) that two or more entities are co-entities based on their determined proximity to each other and/or the duration or number of instances, i, they intersect at the same locations during their time at the establishment (e.g., when i reaches a predefined threshold to be set according to the current store setup).

### III. Use Cases

In the first example embodiment, the absolute distance between the paths of two entities being present at the same time in a store may be determined. Assuming perfect measurements provided by the detection devices 120, a minimal distance between the entities may be zero, meaning the two entities are in fact the same person (e.g., if two mobile devices are carried by the same person). Ground truth from sociology may be used here to define when two paths are “closely related” in a given space in order to assess that under a threshold τ, the distance indicates that two entities are actually visiting together.

In the second example embodiment, two co-entities may not be following each other closely, but are looking for different things and are sometimes re-converging in their path to meet each other. Here again, ground truth may be required to determine whether the entities are close (under Θ centimeters for example), then they are likely to know each other. The final i score may be used to judge the likelihood of co-entities (i.e., the higher the score the more probable they are co-entities).

Additionally, a characteristic zone map (e.g., provided by the operator of the system 100), may mark zones in monitored areas for various importance. This may help in providing a certain importance weight for the co-presence of two or more entities in a given zone. For instance, the presence of two entities at the same time in the entrance or the exit of an establishment may be a meaningful piece of information used to determine multiple entities as co-entities. Accordingly, in the previous example, the incremented value i may be based on the value given by the operator to the detected meeting zone in the characteristic zone map.

For both scenarios, each time two or more entities, i and j for example, are identified to be co-entities, then output O, may be updated to that <i, j> is added as if neither i and j were present individually, and are added as a tuple instead.

### IV. Computer System

Many of the processes and modules described above may be implemented as software processes that are specified as one or more sets of instructions recorded on a non-transitory tangible storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

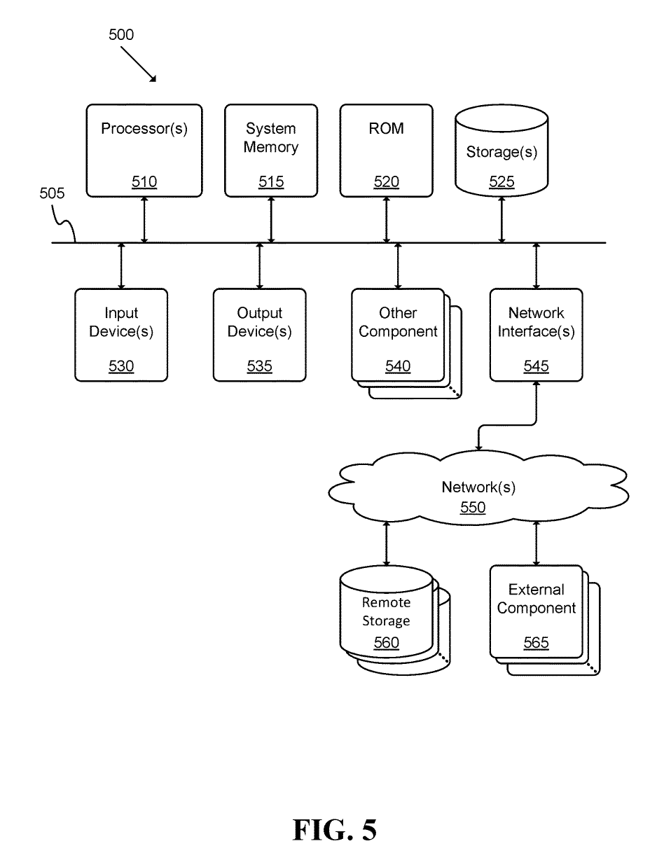

FIG. 5 illustrates a schematic block diagram of an exemplary computer system 500 used to implement some embodiments. For example, the system described above in reference to FIGS. 1-2 may be at least partially implemented using computer system 500. As another example, the processes described in reference to FIG. 3 may be at least partially implemented using sets of instructions that are executed using computer system 500.

Computer system 500 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 500 may include at least one communication bus 505, one or more processors 510, a system memory 515, a read-only memory (ROM) 520, permanent storage devices 525, input devices 530, output devices 535, various other components 540 (e.g., a graphics processing unit), and one or more network interfaces 545.

Bus 505 represents all communication pathways among the elements of computer system 500. Such pathways may include wired, wireless, optical, and/or other appropriate communication pathways. For example, input devices 530 and/or output devices 535 may be coupled to the system 500 using a wired or wireless connection protocol or system.

The one or more processors 510 may, in order to execute the processes of some embodiments, retrieve instructions to execute and/or data to process from components such as system memory 515, ROM 520, and permanent storage device 525. Such instructions and data may be passed over bus 505.

System memory 515 may be a volatile read-and-write memory, such as a random access memory (RAM). The system memory may store some of the instructions and data that the processor uses at runtime. The sets of instructions and/or data used to implement some embodiments may be stored in the system memory 515, the permanent storage device 525, and/or the read-only memory 520. ROM 520 may store static data and instructions that may be used by processor 510 and/or other elements of the computer system.

Permanent storage device 525 may be a read-and-write memory device. The permanent storage device may be a non-volatile memory unit that stores instructions and data even when computer system 500 is off or unpowered. Computer system 500 may use a removable storage device and/or a remote storage device as the permanent storage device.

Input devices 530 may enable a user to communicate information to the computer system and/or manipulate various operations of the system. The input devices may include keyboards, cursor control devices, audio input devices and/or video input devices. Output devices 535 may include printers, displays, and/or audio devices. Some or all of the input and/or output devices may be wirelessly or optically connected to the computer system.

Other components 540 may perform various other functions. These functions may include performing specific functions (e.g., graphics processing, sound processing, etc.), providing storage, interfacing with external systems or components, etc.

Finally, as shown in FIG. 5, computer system 500 may be coupled to one or more networks 550 through one or more network interfaces 545. For example, computer system 500 may be coupled to a web server on the Internet such that a web browser executing on computer system 500 may interact with the web server as a user interacts with an interface that operates in the web browser. Computer system 500 may be able to access one or more remote storages 560 and one or more external components 565 through the network interface 545 and network 550. The network interface(s) 545 may include one or more application programming interfaces (APIs) that may allow the computer system 500 to access remote systems and/or storages and also may allow remote systems and/or storages to access computer system 500 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 500 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

We claim:

1. A method for identifying co-entities in an establishment comprising:
capturing (310) a time series of tuples for each entity during a pre-defined time period, wherein each time series is discretized into time buckets;
generating (330) groups of overlapping time series;
extracting (340) intersections of time series; and
determining (350) that two or more entities are co-entities based on the intersections.

2. The method of claim 1 further comprising:
inferring missing data points in each time series via linear interpolation.

3. The method of claim 1, wherein the tuple comprises a unique identifier for a device, a time stamp, and a location tuple.

4. The method of claim 1, wherein two or more time series are intersecting when the location tuple for a common time bucket in the time series are the same.

5. The method of claim 1 further comprising:
determining the absolute distance between the path of intersecting time series.

6. The method of claim 5, wherein two or more entities are determined to be co-entities when the absolute distance is less than a pre-determined threshold.

7. The method of claim 6, wherein the threshold is based on ground truth from sociology.

8. The method of claim 1 further comprising:
determining, for each time bucket in the intersecting time series, the distance between the devices associated with the intersecting time series; and
incrementing a counter each time the distance between the devices is less than a threshold value.

9. The method of claim 8, wherein two or more entities are determined to be co-entities when the counter is greater than a counter threshold value.

10. The method of claim 9, wherein the counter threshold value is a percentage based on the amount of time the two or more time series were present in the establishment.

11. The method of claim 8, wherein different location tuples are assigned different counter increment values based on zones defined by a characteristic zone map.

12. An apparatus for identifying co-entities in an establishment comprising:
a processor for executing a set of instructions; and
a non-transitory medium that stores the set of instructions, wherein the set of instructions comprises the method of claims 1-11.
